(19) United States
(12) Patent Application Publication
(10) Pub. No.: US 2016/0237874 A1
(43) Pub. Date: Aug. 18, 2016

(54) CATALYST ASSEMBLY WITH SENSING ADAPTER SYSTEM

(71) Applicant: General Electric Company, Schenectady, NY (US)

(72) Inventors: Joshua James Lavalle, Waukesha, WI (US); Dennis John Spaulding, Waukesha, WI (US)

(21) Appl. No.: 14/621,122

(22) Filed: Feb. 12, 2015

(51) Int. Cl. F01N 11/00; F01N 13/00; F02B 77/08; F01N 3/10

(52) U.S. Cl. CPC F01N 11/007; F01N 3/101; F01N 13/008; F02B 77/086; F01N 2550/04

(57) ABSTRACT

A system includes a cylindrical portion coupled to a conically-shaped outlet portion of a three-way catalyst assembly. The cylindrical portion is coupled to the conically shaped outlet portion along a fluid flow path exiting the conically-shaped outlet portion. The cylindrical portion is coupled to a narrower end of the conically-shaped outlet portion. At least one oxygen sensor connection is disposed on the cylindrical portion to enable an oxygen sensor coupled to the at least one oxygen sensor connection to be disposed perpendicular to a longitudinal axis of the cylindrical portion.

### BACKGROUND

The subject matter disclosed herein relates to reciprocating engines and, more specifically, to aftertreatment systems coupled to reciprocating engines.

Engines (e.g., internal combustion engines such as gas engines) combust a mixture of fuel and air to generate combustions gases that apply a driving force to a component of the engine (e.g., to move a piston). Subsequently, the combustion gases exit the engine as an exhaust gas and may be treated in an aftertreatment system. Unfortunately, quality samples representative of the emissions of nitrogen oxides (NOₓ), oxygen (O₂), and other components in the treated exhaust gases may be difficult to obtain.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a catalyst assembly configured to mount along an exhaust flow path of a reciprocating combustion engine is provided. The catalyst assembly includes a housing having an inlet portion, an outlet portion, and a central portion disposed between the inlet portion and the outlet portion. The housing is configured to house one or more catalyst elements. The housing includes a flow path through the inlet portion, the central portion, and the outlet portion. The outlet portion has a first end and a second end, the first end being coupled to the central portion, and the outlet portion includes a first annular wall having a first diameter that decreases from the first end to the second end. The catalyst assembly also includes a cylindrical portion coupled to and extending from the second end of the outlet. The catalyst assembly further includes at least one oxygen sensor connection disposed on the cylindrical portion to enable an oxygen sensor coupled to the at least one oxygen sensor connection to be disposed perpendicular to a longitudinal axis of the cylindrical portion.

In accordance with a second embodiment, a system includes a cylindrical portion configured to be coupled to a conically-shaped outlet portion of a three-way catalyst assembly along a fluid flow path exiting the conically-shaped outlet portion, such that the cylindrical portion is configured to be coupled to a narrower end of the conically-shaped outlet portion. The system also includes at least one oxygen sensor connection disposed on the cylindrical portion to enable an oxygen sensor coupled to the at least one oxygen sensor connection to be disposed perpendicular to a longitudinal axis of the cylindrical portion.

In accordance with a third embodiment, a catalyst assembly configured to mount along an exhaust flow path of a reciprocating combustion engine is provided. The catalyst assembly includes a housing having an inlet portion, an outlet portion, a central portion disposed between the inlet portion and the outlet portion and configured to house one or more catalyst elements. The housing also includes a flow path through the inlet portion, the central portion, and the outlet portion. The outlet portion has a first end and a second end, and the first end is coupled to the central portion, and the outlet portion includes a conical wall having a first diameter that decreases from the first end to the second end. The catalyst assembly also includes a cylindrical portion coupled to and extending from the second end of the outlet. The catalyst assembly further includes at least one oxygen sensor connection disposed on the cylindrical portion to enable an oxygen sensor coupled to the at least one oxygen sensor connection to be disposed perpendicular to a longitudinal axis of the cylindrical portion. The central portion has a cross-sectional area adjacent the first end of the outlet portion, the at least one oxygen sensor has a second diameter, and the ratio of the cross-sectional area to the second diameter is approximately between 16.4:1 m²/m to 65.7:1 m²/m.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an engine driven system (e.g., engine driven power generation system) coupled to an aftertreatment system (e.g., catalyst assembly) having a plurality of sensors disposed on a cylindrical portion extending from an end of a catalyst housing outlet;

FIG. 2 is a cross-sectional side view of an embodiment of the aftertreatment system of FIG. 1 having a cylindrical portion extending from an end of a catalyst housing outlet;

FIG. 3 is a cross-sectional view of an embodiment of a catalyst assembly having a plurality of sensors within the cylindrical portion, taken along line 3-3 of FIG. 2;

FIG. 4 is a cross-sectional view of an embodiment of an oxygen sensor connection (e.g., boss) disposed in an annular wall of the cylindrical portion, taken within line 4-4 of FIG. 3;

FIG. 5 is a cross-sectional view of an embodiment of a non-oxygen sensor boss disposed in the annular wall of the cylindrical portion, taken within line 5-5 of FIG. 3; and

FIG. 6 is a cross-sectional side view of an embodiment a cylindrical portion coupled to an end of an outlet portion of a catalyst assembly.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems that enable improved sensor readings of emissions from a catalyst assembly. In particular, embodiments of the present disclosure include a catalyst assembly (e.g., three-way catalyst (TWC)) configured to couple to and receive exhaust from an internal combustion engine (e.g., a reciprocating engine such as a gas engine). The catalyst assembly includes a housing and one or more catalyst elements. The housing of the catalyst assembly includes an inlet portion, an outlet portion, and a central portion disposed between the inlet and outlet portion. A cylindrical portion is coupled to and extends from the outlet portion (e.g., the cylindrical portion and the outlet portion may form a single piece). Alternatively, the cylindrical portion may be a separate piece permanently or removably coupled to the outlet portion. One or more sensors are disposed perpendicular to a longitudinal axis of the cylindrical portion. For example, the sensors may include sensors configured to measure an oxygen concentration or a nitrogen oxide composition or other compositions within a sample (e.g., of exhaust flow or treated exhaust flow). By orienting the sensors perpendicular to the longitudinal axis of the cylindrical portion, more accurate readings of emissions may be gathered due to the turbulent but homogeneous flow at the wall through the cylindrical portion. In other words, the treated exhaust flow experiences turbulent albeit more consistent flow as it flows through cylindrical portion. Absent the cylindrical portion, readings taken from sensors disposed on the conical wall of the catalyst assembly cause the readings to fluctuate or be less accurate largely due to the converging turbulent flows causing voids and non-homogenous flow the sensors experience as the treated exhaust flow flows along the angled or conical wall section of the outlet portion. Accordingly, adding a cylindrical portion enables better quality (e.g., more accurate) measurements of constituents within the flow exiting the catalyst assembly.

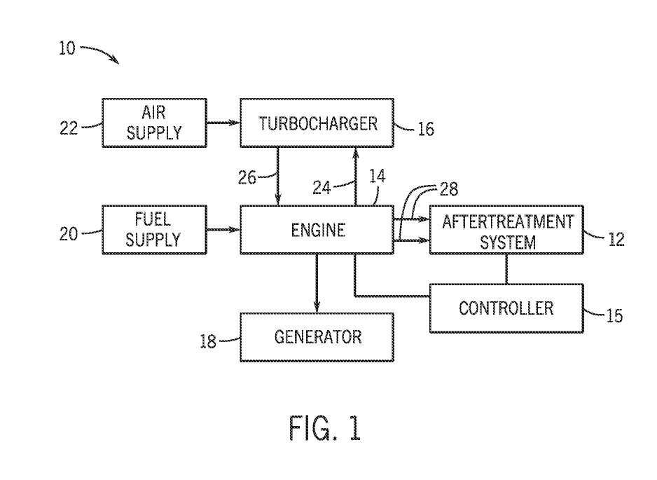

Turning now to the drawings and referring first to FIG. 1, a block diagram of an embodiment of an engine driven system 10 (e.g., engine driven power generation system) coupled to an aftertreatment (e.g., catalyst assembly) having a plurality of sensors disposed on a cylindrical portion extending from an end of a catalyst housing outlet. The engine 14 may include a reciprocating or piston engine (e.g., internal combustion engine). The engine 14 may include a spark-ignition engine or a compression-ignition engine. The engine 14 may include a natural gas engine, gasoline engine, diesel engine, or dual fuel engine. The engine 14 may be a two-stroke engine, three-stroke engine, four-stroke engine, five-stroke engine, or six-stroke engine. The engine 14 may also include any number of cylinders (e.g., 1-24 cylinders or any other number of cylinders) and associated piston and liners. In some such cases, the cylinders and/or the pistons may have a diameter of between approximately 13.5-34 centimeters (cm). In some embodiments, the cylinders and/or the pistons may have a diameter of between approximately 10-40 cm, 15-25 cm, or about 15 cm. The system 10 may generate power ranging from 10 kW to 10 MW. In some embodiments, the engine 14 may operate at less than approximately 1800 revolutions per minute (RPM). In some embodiments, the engine 14 may operate at less than approximately 2000 RPM, 1900 RPM, 1700 RPM, 1600 RPM, 1500 RPM, 1400 RPM, 1300 RPM, 1200 RPM, 1000 RPM, 900 RPM, or 750 RPM. In some embodiments, the engine 14 may operate between approximately 750-2000 RPM, 900-1800 RPM, or 1000-1600 RPM. In some embodiments, the engine 14 may operate at approximately 1800 RPM, 1500 RPM, 1200 RPM, 1000 RPM, or 900 RPM. Exemplary engines 14 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example. The engine 14 is coupled to a controller 15 that controls the operation of the engine 14 (e.g., fuel/air ratio, fuel injection timing, ignition timing, etc.). In certain embodiments, the controller 15 may also be coupled to the aftertreatment system 12.

The power generation system 10 includes the engine 14, a turbocharger 16, and a generator 18 (e.g., electrical generator). In certain embodiments, instead of the generator 18, the engine 14 is coupled to a mechanical drive or machinery. Depending on the type of engine 14, the engine 14 receives fuel 20 (e.g., diesel, natural gas, coal seam gases, associated petroleum gas, etc.) or a mixture of both the fuel 20 and a pressurized oxidant 22, such as air, oxygen, oxygen-enriched air, or any combination thereof. Although the following discussion refers to the oxidant as the air 22, any suitable oxidant may be utilized with the disclosed embodiments. The fuel 20 or mixture of fuel 20 and pressurized air 22 is fed into the engine 14. The engine 14 combusts the mixture of fuel 20 and air 22 to generate hot combustion gases, which in turn drive a piston (e.g., reciprocating piston) within a cylinder liner. In particular, the hot combustion gases expand and exert a pressure against the piston that linearly moves the piston from a top portion to a bottom portion of the cylinder liner during an expansion stroke. The piston converts the pressure exerted by the combustion gases (and the piston's linear motion) into a rotating motion (e.g., via a connecting rod and a crank shaft coupled to the piston). The rotation of the crank shaft drives the electrical generator 18 to generate power. Alternatively, the crank shaft drives a mechanical drive or machinery. In certain embodiments, exhaust 24 from the engine 14 may be provided to the turbocharger 16 and utilized in a turbine portion of the turbocharger 16, thereby driving a compressor of the turbocharger 16 to pressurize the air 22 as indicated by reference numeral 26. As mentioned above, exhaust 28 from the engine 14 is provided to the aftertreatment system 12 for treatment (e.g., the reduction of emissions within the exhaust 28). In some embodiments, the power generation system 10 may not include all of the components illustrated in FIG. 1. In addition, the power generation system 10 may include additional components such as an exhaust stack, silencer, control components, and/or heat recovery components. In certain embodiments, the turbocharger 16 may be utilized as part of the heat recovery components. The system 10 may generate power ranging from 10 kW to 10 MW or greater. Besides power generation, the system 10 may be utilized in other applications such as those that recover heat and utilize the heat (e.g., combined heat and power applications), combined heat, power, and cooling applications, applications that also recover exhaust components (e.g., carbon dioxide) for further utilization, gas compression applications, and mechanical drive applications. Embodiments of the present disclosure include a catalyst assembly configured to couple to and receive exhaust from an engine 14. The catalyst assembly includes a housing and one or more catalyst elements. The housing of the catalyst assembly includes an inlet portion, an outlet portion, and a central portion disposed between the inlet and outlet portion. A cylindrical portion is coupled to and extends from the outlet portion enabling emissions to be sampled through a plurality of one or more sensors disposed perpendicular to a longitudinal axis of the cylindrical portion.

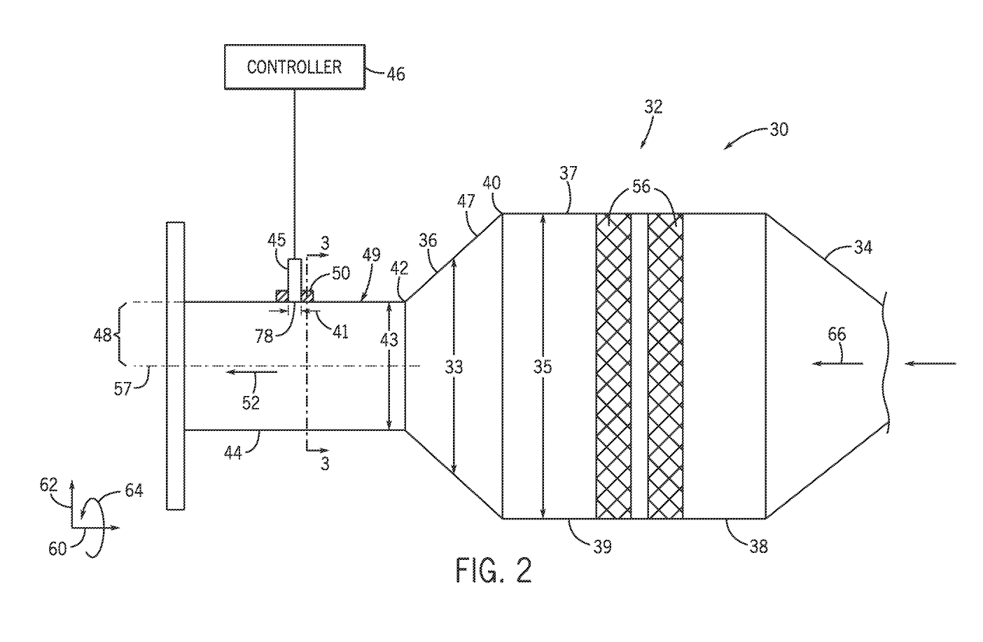

FIG. 2 is a cross-sectional side view of an embodiment of the aftertreatment system 12 of FIG. 1 having a cylindrical portion 44 extending from an end of a catalyst housing outlet. In the following discussion, reference may be made to a longitudinal or axial direction 60, a radial direction 62, and/or a circumferential direction 64 of the catalyst assembly 30. The aftertreatment system 12 may include a catalytic converter or catalyst assembly (e.g., TWC assembly or SCR assembly) to treat or reduce emissions within the exhaust generated by the engine 14. The catalyst assembly 30 includes a catalyst housing 32 having an inlet portion 34, and outlet portion 36, and central portion 38 disposed between the inlet portion 34 and the outlet portion 36. The outlet portion 36 has a first end 40 and a second end 42. A cylindrical portion 44 is coupled to and extends from the second end 42 of the outlet portion 36. One or more sensors 45 (e.g., emissions sensors, such as oxygen sensors, NOₓ sensors, or other types of sensors) are coupled to the cylindrical portion 44 of the catalyst housing 32 of the catalyst assembly 30. The sensors 45 may be disposed perpendicular to a longitudinal axis 57 of the cylindrical portion 44. For example, the sensors 45 are disposed along an upper half 48 of the annular wall 49. The sensors 45 are disposed in a sensor boss 50, such that at least a portion of the sensor boss 50 and/or sensor 45 protrude through the cylindrical portion 44 into the treated exhaust flow 52 to enable collection and/or analysis of a sample of the treated exhaust flow 52 (e.g., treated via one or more catalyst elements 56 within the housing of the catalyst assembly). The sensors 45 may be coupled to a controller 46 which may adjust the air/fuel ratio, fuel injection timing, or other control measures. The catalyst assembly 30 includes an inlet portion 34 to receive the exhaust flow 66 generated by the engine 14, one or more catalyst elements 56 (e.g., to promote the treatment and reduction of emissions such as O₂, NO_{X}, SO_{X}, hydrocarbons, and CO), and an outlet portion 36 to discharge the treated exhaust flow 52. One or more of the sensors 45 are disposed on the cylindrical portion 44 positioned at the outlet portion 36 of the catalyst housing 32. In some embodiments, one or more sensors 45 on the upper half 48 of the annular wall 49 of the cylindrical portion 44. The positioning of the sensors 45 may be placed on the upper half 48 of the annular wall 49 keeps moisture (e.g., condensation) from collecting and damaging the sensors 45. As with the cylindrical portion 44, the sensors 45 may be removably coupled (e.g., bolted or screwed) to the annular wall 49 of the cylindrical portion 44. As such, the sensors 45 may be disposed within the sensor bosses 50 into the annular wall 49 via a removable fitting, such as a compression fitting, a threaded fitting, seals or gaskets, clamps, or a combination thereof. Providing the sensors 45 as part of the catalyst assembly 30 disposed in the cylindrical portion 44 enables consistent emissions readings within the treated exhaust flow 52. The cylindrical portion 44 may be coupled to second end 42 of the outlet portion 36 of the catalyst housing 32. The cylindrical portion 44 may be permanently or removably (e.g, bolts, nuts, screws) coupled to the outlet portion 36. The cylindrical portion 44 may be permanently coupled (e.g. welded) to the outlet portion 36 such that the cylindrical portion 44 and the outlet portion 36 form a single piece. Absent a cylindrical portion 44, readings taken from sensors 45 disposed on the conical wall of the catalyst assembly 30 cause the readings to fluctuate largely due to the voids and non-homogenous flow the sensors experience as the treated exhaust flow 52 flows through the outlet portion 36. Accordingly, disposing the cylindrical portion 44 to the outlet portion 36 enables better quality samples to be taken because the treated exhaust flow 52 experiences more consistent (e.g., turbulent and homogeneous) flows as it flows through the cylindrical portion 44 of the catalyst assembly 30. As such, the turbulent and homogeneous flows enable better (i.e., more accurate) measurement of emissions in the treated exhaust flow 52.

The outlet portion 36 includes an annular wall 47 (e.g., conical wall) that includes a diameter 33 that decreases from the first end 40 to the second end 42. The central portion 38 has a cross sectional area 35 adjacent the first end 40 of the outlet portion 36, defined in part by a top wall 37 and a bottom wall 39 of the central portion 38. In certain embodiments, the central portion 38 may include a single annular wall. The at least one oxygen sensor 58 has a diameter 41 where the sensor interfaces with the treated exhaust flow 52. In one example, the portion 78 of the sensor 45 has may have a diameter of approximately 1.03 centimeters (cm). The diameter 41 range from approximately 0.25 to 2.54 cm, 0.64 to 1.91 cm, or 0.84 to 1.27 cm, and all subranges therebetween. The cross sectional area 35 may have a range from approximately 0.14 to 0.7 m², to 0.15 to 0.6 m², to 0.16 to 0.5 m², and all subranges therebetween. The ratio of the cross sectional area 35 to the second diameter 41 may range from approximately 15:1 m²/m to 70:1 m²/m, to 16:1 m²/m to 65 m²/m, to 16.4:1 m²/m to 65.7:1 m²/m, and all subranges therebetween. The outlet portion 36 of the catalyst assembly 30 includes a first end 40 and a second end 42. A cylindrical portion 44 is coupled to and extends from the second end 42 of the outlet and includes an annular wall 49. The diameter 43 of the cylindrical portion 44 may range from approximately 20.3 to 35.6 cm, 22.3 to 30.5 cm, 25.4 to 27.9 cm, and all subranges therebetween. The ratio of the diameter 43 to the second diameter 41 may be approximately 18:1 to 40:1, 20.1:1 to 36:1, 19.7:1 to 34.5:1, and all subranges therebetween.

The inlet portion 34 of the catalyst assembly 30 receives an exhaust flow 66 from the engine 14 (e.g., gas engine). The exhaust flow 66 flows along the exhaust flow 66 path in an axial direction 60 from the inlet portion 34 towards the outlet portion 36. The one or more catalyst elements 56 promote the reduction of emissions within the exhaust flow 66 path to generate a treated exhaust flow 52 that flows downstream from the catalyst elements 56 to the outlet in the axial direction 60, where the treated exhaust flow 52 is discharged from the catalyst assembly 30 (e.g., to a silencer and/or exhaust stack). The catalyst assembly 30 may include an oxidation catalyst, a carbon monoxide reduction catalyst, a nitrogen oxides reduction catalyst, or any other type of catalyst. In certain embodiments, the catalyst assembly 30 may be a three-way catalyst (TWC) assembly. For example, the catalyst assembly 30, via the catalyst elements 56 and their catalytic activity, reduces NO_{X} via multiple reactions. For example, NO_{X} may be reduced via CO to generate N₂ and CO₂, NO_{X} may be reduced via H₂ to generate NH₃ and water, and NO_{X} may be reduced via a hydrocarbon (e.g., C₃H₆) to generate N₂, CO₂, and water. The catalyst assembly 30 may also oxidize CO to CO₂, and oxidize unburnt HC to CO₂ and water. The catalyst elements 56 may include one or more of aluminum oxide, zirconium oxide, silicone oxide, titanium oxide, platinum oxide, palladium oxide, cobalt oxide, mixed metal oxide, or any other type catalytic material.

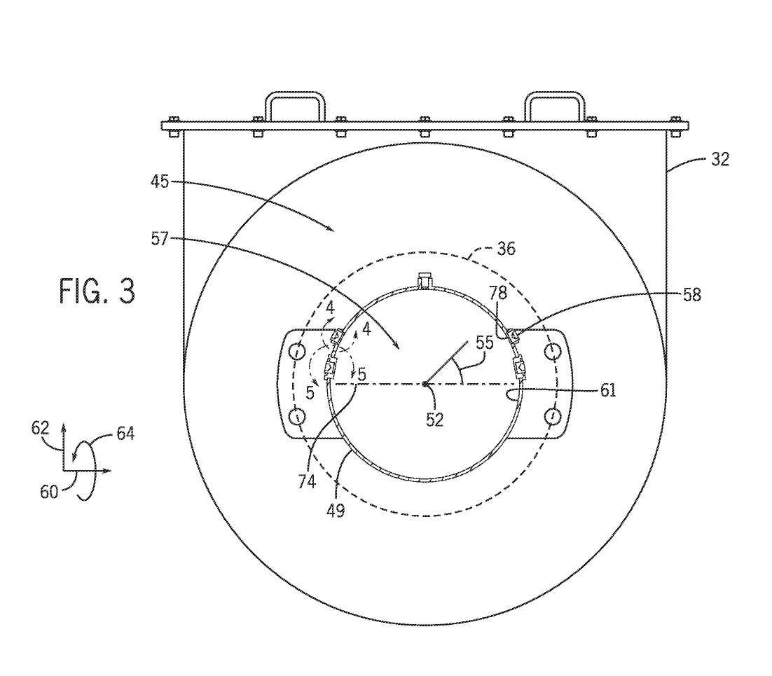

The cylindrical portion 44 of the catalyst assembly 30 includes one or more sensors 45 (e.g., O₂ sensors, NOₓ sensors) disposed on the annular wall 49 of the cylindrical portion 44. Each sensor 45 samples the treated exhaust flow 52 to provide more accurate readings of the treated exhaust flow 52 emissions compared to sensors 45 disposed on the conical wall of the catalyst assembly 30. The cylindrical portion 44 provides better quality samples to be taken because the treated exhaust flow 52 experiences more turbulent and homogeneous flows as it flows through the cylindrical portion 44 of the catalyst assembly 30. As such, the turbulent and homogeneous flows enable the sample to provide a better sample that is representative of the emissions remaining in the treated exhaust flow 52, compared to the treated exhaust flow 52 flowing through the conical (e.g., inclined, angular) wall. The sensors 45 may be disposed at different circumferential and/or radial 36 positions about and along the cylindrical portion 44 with respect to each other. In one embodiment, the sensors 45 may be disposed perpendicular to a longitudinal axis 57 of the cylindrical portion 44. An upper half 48 of the cylindrical portion 44 may be defined as the portion above a plane (see FIG. 3) positioned in the axial direction 60 and extending from the plane through the diameter 43 of the cylindrical portion 44 in the radial direction 62. For example, the sensors 45 may be disposed at an angle 55 of approximately −90 degrees to 0 degrees and from approximately 0 degrees to 90 degrees on an upper half 48 of the cylindrical portion 44. The upper half 48 of the cylindrical portion 44 is defined as the portion above a plane positioned in the axial direction 60 and extending through the diameter 43 of the cylindrical portion 44. In certain embodiments, the desired sensor 45 placement with respect to the upper half 48 may range from approximately −90 to 90 degrees, −60 to 60 degrees, −30 to 30 degrees, and all subranges therebetween. Positioning the sensors 45 on the upper half 48 of the annular wall 49 enables the sensors 45 to avoid collecting undue moisture content accumulating when the equipment of the engine drive system 10, including the exhaust treatment system 12, is started up or shut down. As depicted, the sensors 45 may be connected to the cylindrical portion 44 of the catalyst assembly 30 downstream of the catalyst elements 56.

Each sensor 45 includes a portion 78 that extends into fluid flow (e.g., treated exhaust flow) within the annular wall 49 of the catalyst assembly 30. The portion 78 may be disposed within the treated exhaust flow 52 to enable the collection of a sample of the treated exhaust flow 52 within the cylindrical portion 44. Sampling the treated exhaust flow 52 from the cylindrical portion 44 of the catalyst assembly 30 provides a better location within the catalyst assembly 30 to dispose the sensors 45 to obtain more accurate measurements. Installing the sensors 45 on the conical or angled wall of the catalyst assembly 30 causes the readings to fluctuate largely due to the turbulent and non-homogeneous flows the treated exhaust flow 52 experiences as it exits the catalyst elements 56. As will be appreciated, the treated exhaust flow 52 experiences more turbulent and homogeneous flows as it flows through the cylindrical portion 44 of the catalyst assembly 30. As such, the turbulent and homogeneous flows enable the sample to provide a better sample that is representative of the emissions remaining in the treated exhaust flow 52, compared to the treated exhaust flow 52 flowing through the conical (e.g., inclined, angular) wall.

The sensors 45 may be disposed within and coupled to the annular wall 49 via a variety of mounts. For example, the sensors 45 may be disposed or removably mounted within annular wall 49 via a compression fitting, a threaded fitting, clamps or any combination thereof. Alternatively, the sensors 45 may be fixedly coupled (e.g., welded) to the annular wall 49. The sensors 45 are configured to couple to the controller 46. The controller 46 may adjust fuel/air ratio, fuel injection timing, ignition timing, and/or other control measures. Some of these functions may include analyzing emissions emitted by the engine 14 prior to treatment and/or analyzing emissions after treatment. This information may be utilized to access the performance of the engine 14, fuel utilized with the engine 14, the performance of the catalyst assembly 30 (e.g., for aging or deactivation), emissions compliance, control purposes, and as well as other purposes. As mentioned above, providing the sensors 45 as part of the catalyst assembly 30 enables consistent readings within the treated exhaust flow 52.

FIG. 3 is a cross-sectional view of an embodiment of a catalyst assembly 30 having a plurality of sensors 45 within the cylindrical portion 44, taken along line 3-3 of FIG. 2. The sensors 45 can be exposed to the treated exhaust flow 52 to measure emissions in the treated exhaust flow 52. In some embodiments, the portion 78 of the sensor 45 includes a round shape, such as a circle, oval, ellipse, and so forth. The portion 78 that interfaces with the flow of the sensor 45 can have a diameter 41 range from approximately 0.25 to 2.54 cm, 0.64 to 1.91 cm, or 0.84 to 1.27 cm, and all subranges therebetween. In one example, the portion 78 of the sensor 45 may have a diameter of approximately 1.03 centimeters. As described above, the cylindrical portion 44 extends from and is coupled to the second end 42 of the outlet portion 36 of the catalyst housing 32. As described herein, the diameter of the outlet portion 36 of the catalyst housing 32, and in turn the diameter 43 of the cylindrical portion 44 may range from approximately 20.3 to 35.6 cm, 22.3 to 30.5 cm, 25.4 to 27.9 cm, and all subranges therebetween. The ratio of the diameter 43 to the diameter 41 may be approximately 18:1 to 40:1, 20.1:1 to 36:1, 19.7:1 to 34.5:1, and all subranges therebetween. In some embodiments, the cylindrical portion 44 may include a circular cylinder shape, an ovular cylinder shape, an elliptical cylinder shape, and so forth. In some embodiments, the cylindrical portion 44 may be replaced with a portion having any other polygonal shape, such as a square, rectangular, other quadrilateral, hexagon, octagon, and so forth. The polygonal shape may include equilateral or non-equilateral sides.

In one embodiment, a system comprises a cylindrical portion 44 configured to be coupled to a conically-shaped outlet portion 36 of a three-way catalyst assembly 30 along the treated exhaust flow 52 exiting the conically-shaped outlet portion 36, such that the cylindrical portion 44 is configured to be coupled to the second end 42 of the conically-shaped outlet portion 36, and at least one oxygen sensor 58 connection is disposed on the cylindrical portion 44 to enable an oxygen sensor 58 to be coupled to at least one oxygen sensor 58 connection. The oxygen sensor 58 can be disposed perpendicular to the longitudinal axis 57 of the cylindrical portion 44. In some embodiments, the three-way catalyst includes an inlet portion 34 and a central portion 38 disposed between the inlet portion 34 and the conically-shaped outlet portion 36, such that the central portion 36 has a first diameter 33 adjacent a wider end of the conically-shaped outlet portion 36, and the at least one oxygen sensor 58 has a second diameter 41.

The present disclosure utilizes catalysts ranging in size from approximately 0.36 m to approximately 0.91 m. In some embodiments, the catalysts may be utilized in a portion having another any other polygonal shape, such as a square, rectangular, other quadrilateral, hexagon, octagon, and so forth. The polygonal shape may include equilateral or non-equilateral sides. The non-cylindrical portion is coupled to and extends from the second end 42 of the outlet portion 36 of the catalyst housing 32. In one embodiment, a non-cylindrical portion used to accommodate a 0.45 m catalyst section may have a catalyst cross sectional area 35 of approximately 0.16 m². A non-cylindrical portion used to accommodate a 0.91 m catalyst section may have a catalyst cross sectional area 35 of approximately 0.66 m². Utilizing an oxygen sensor 58 with the portion 78 of approximately 0.01 m, the catalyst cross sectional area to portion 78 of the oxygen sensor 58 diameter can be about 16.4:1 m²/m when an 0.46 m catalyst is utilized to about 65.7:1 m²/m when a 0.91 m catalyst is utilized. The catalyst cross sectional area 35 to portion 78 of the oxygen sensor 58 diameter may range from approximately 15:1 m²/m to 70:1 m²/m, to 16:1 m²/m to 65 m²/m, to 16.4:1 m²/m to 65.7:1 m²/m, and all subranges therebetween.

Utilizing the cylindrical portion 44 rather than other shaped portions can reduce the above ratios. In one embodiment, a 0.20 m diameter cylindrical portion 44 may have a cross sectional area of 0.03 m². A 0.36 m diameter cylindrical portion 44 may have a cross sectional area of 0.1 m². Utilizing an oxygen sensor 58 with the portion 78 of approximately 0.01 m, the catalyst cross-sectional area may have a ratio of approximately 3 m²/m to 10 m²/m. The ratio of the catalyst cross sectional area to portion 78 of the oxygen sensor 58 may range from 1 to 12 m²/m, 2 to 11 m²/m, and 3 to 10 m²/m, and all subranges therebetween.

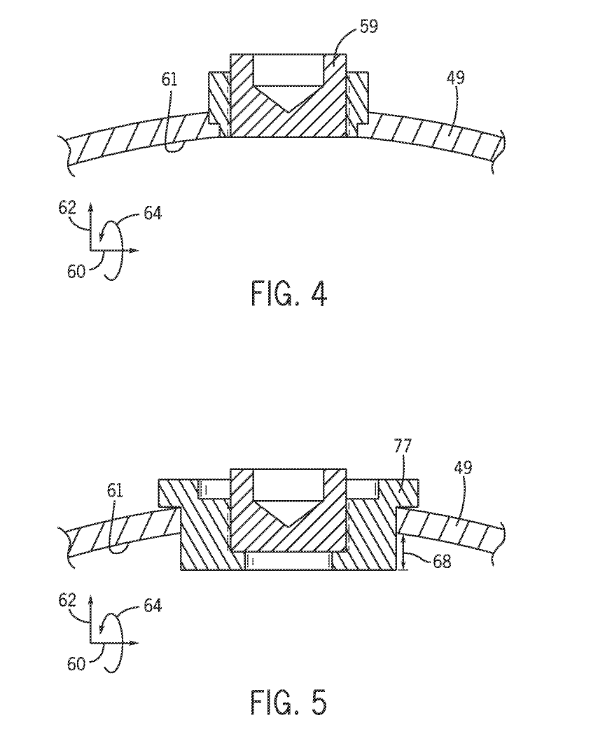

FIG. 4 is a cross-sectional side view of an embodiment of an oxygen sensor connection (e.g., boss) disposed in the annular wall 49 of the cylindrical portion 44, taken within line 4-4 of FIG. 3. As described above, one or more sensors 45 may be utilized in the cylindrical portion 44 of the catalyst assembly 30. The sensors 45 may include one or more oxygen sensors 58. The oxygen sensor 58 may be coupled to the cylindrical portion 44 via an oxygen sensor boss 59. The one or more oxygen sensors 58 and oxygen sensor bosses 59 may be disposed along the upper half 48 of the cylindrical portion, as described above with respect to the sensors 45. The upper half 48 of the cylindrical portion 44 may be defined as the portion above a plane 74 positioned in the axial direction 60 and extending from the plane 74 through the diameter 43 of the cylindrical portion 44 in the radial direction 62. For example, the oxygen sensors 58 may be disposed at an angle 55 of approximately −90 degrees to 0 degrees and from approximately 0 degrees to 90 degrees on the upper half 48 of the cylindrical portion 44. In certain embodiments, the desired oxygen sensor 58 placement with respect to the upper half 48 may range from approximately −90 to 90 degrees, −60 to 60 degrees, −30 to 30 degrees, and all subranges therebetween. Positioning the oxygen sensors 58 on the upper half 48 of the annular wall 49 enables the oxygen sensors 58 to avoid collecting undue moisture content accumulating when the equipment of the engine drive system 10, including the exhaust treatment system 12, is started up or shut down. In certain embodiments, the oxygen sensor boss 59 may extend beyond an inner surface 61 of the annular wall 49, such that the oxygen sensor boss 59 is exposed to the treated exhaust flow 52. As such, the oxygen sensor 58 may also be exposed to the treated exhaust flow 52. The oxygen sensor boss 59 may include a threaded surface to enable to the oxygen sensor boss 59 to extend further into the annular wall 49 such that a greater portion 68 of the oxygen sensor boss 59 or oxygen sensor 58 may be exposed to the treated exhaust flow 52. The oxygen sensor 58 and oxygen sensor boss 59 may be able to extend a further into the treated exhaust flow 52 (e.g., in the radial direction 62) by utilizing threads, channels, screws, and so forth on the oxygen sensor boss 59.

FIG. 5 is a cross-sectional side view of a non-oxygen sensor boss 77 disposed within an annular wall 49 of the cylindrical portion 44, taken within line 5-5 of FIG. 3. As described above, one or more sensors 45 may be utilized in the cylindrical portion 44 of the catalyst assembly 30. The sensors 45 may include one or more non-oxygen sensors 76. The non-oxygen sensor 76 may be coupled to the cylindrical portion 44 via a non-oxygen sensor boss 77. The one or more non-oxygen sensors 76 and non-oxygen sensor bosses 77 may be disposed along the upper half 48 of the cylindrical portion 44, as described above with respect to the sensors 45. The upper half 48 of the cylindrical portion 44 may be defined as the portion above the plane 74 positioned in the axial direction 60 and extending from the plane 74 through the diameter 43 of the cylindrical portion 44 in the radial direction 62. For example, the non-oxygen sensors 76 may be disposed at an angle 55 of approximately −90 degrees to 0 degrees and from approximately 0 degrees to 90 degrees on an upper half 48 of the cylindrical portion 44. In certain embodiments, the desired non-oxygen sensor 76 placement with respect to the upper half 48 may range from approximately −90 to 90 degrees, −60 to 60 degrees, −30 to 30 degrees, and all subranges therebetween. Positioning the non-oxygen sensors 76 on the upper half 48 of the annular wall 49 enables the non-oxygen sensors 76 to avoid collecting undue moisture content accumulating when the equipment of the engine drive system 10, including the exhaust treatment system 12, is started up or shut down. In certain embodiments, the non-oxygen sensor boss 77 may extend beyond an inner surface 61 of the annular wall 49, such that the non-oxygen sensor boss 77 is exposed to the treated exhaust flow 52. As such, the non-oxygen sensor 76 may also be exposed to the treated exhaust flow 52. The non-oxygen sensor boss 77 may include a threaded surface to enable to the non-oxygen sensor boss 77 to extend further into the annular wall 49 such that a greater portion 68 of the non-oxygen sensor boss 77 or non-oxygen sensor 76 may be exposed to the treated exhaust flow 52. The non-oxygen sensor 76 and non-oxygen sensor boss 77 may be able to extend further into the treated exhaust flow 52 (e.g, a greater distance in the radial direction 62) by utilizing threads, channels, screws, and so forth on the non-oxygen sensor boss 77.

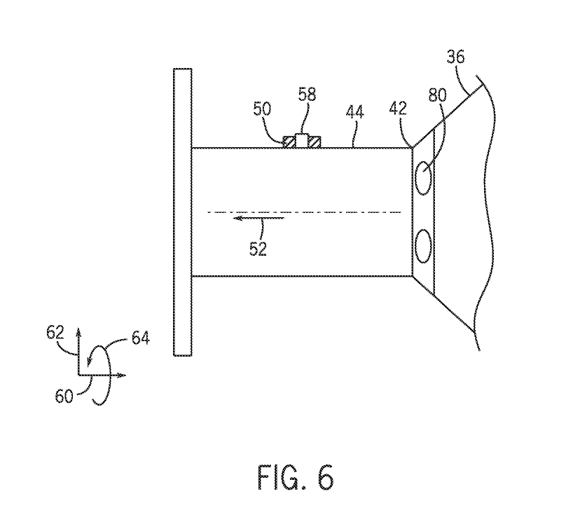

FIG. 6 is a cross-sectional side view of an embodiment a cylindrical portion 44 coupled to an end 42 of an outlet portion 36 of a catalyst assembly 30. The cylindrical portion 44 may be removably coupled to the second end 42 of the catalyst housing 32 by utilizing epoxies or adhesives or mechanically assembling the cylindrical portion 44 to the second end 42 of the catalyst housing via bolts 80, nuts, screws, and so forth. In other embodiments, the cylindrical portion 44 may be permanently coupled to the second end 42 of the catalyst housing 32 by welding the cylindrical portion 44 to the outlet portion 36. In other embodiments, the cylindrical portion 44 may be permanently coupled to the second end 42 of the outlet portion 36 by spot welding, utilizing rivets, and soldering the pieces together, and so forth.

Technical effects of the disclosed embodiments include systems that enable improved sensor readings of emissions from a catalyst assembly. In particular, embodiments of the present disclosure include a catalyst assembly (e.g., three-way catalyst (TWC)) configured to couple to and receive exhaust from an internal combustion engine (e.g., a reciprocating engine such as a gas engine). The catalyst assembly includes a housing and one or more catalyst elements. The housing of the catalyst assembly includes an inlet portion, an outlet portion, and a central portion disposed between the inlet and outlet portion. A cylindrical portion is coupled to and extends from the outlet portion. One or more sensors are disposed perpendicular to a longitudinal axis of the cylindrical portion. The sensors may include sensors configured to measure an oxygen concentration or a nitrogen oxide composition or other compositions within a sample (e.g., of exhaust flow or treated exhaust flow). By orienting the sensors perpendicular to the longitudinal axis of the cylindrical portion, more accurate readings of emissions may be gathered due to the turbulent and homogeneous flow through the cylindrical portion. Absent the cylindrical portion, readings taken from sensors disposed on the conical wall of the catalyst assembly cause the readings to fluctuate or be less accurate largely due to the the converging turbulent flows causing voids and non-homogenous flow the sensors experience as the treated exhaust flow flows along the angled or conical wall section of the outlet portion.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A catalyst assembly configured to mount along an exhaust flow path of a reciprocating combustion engine, comprising:
a housing having an inlet portion, an outlet portion, a central portion disposed between the inlet portion and the outlet portion and configured to house one or more catalyst elements, and a flow path through the inlet portion, the central portion, and the outlet portion, wherein the outlet portion has a first end and a second end, the first end being coupled to the central portion, and the outlet portion comprises a first annular wall having a first diameter that decreases from the first end to the second end;
a cylindrical portion coupled to and extending from the second end of the outlet; and
at least one oxygen sensor connection disposed on the cylindrical portion to enable an oxygen sensor coupled to the at least one oxygen sensor connection to be disposed perpendicular to a longitudinal axis of the cylindrical portion.

2. The catalyst assembly of claim 1, wherein the first annular wall of the outlet portion comprises a conical wall.

3. The catalyst assembly of claim 1, wherein the central portion has a cross sectional area, the at least one oxygen sensor has a second diameter, and the ratio of the cross sectional area to the second diameter is 16.4:1 m²/m to approximately 65.7:1 m²/m.

4. The catalyst assembly of claim 1, comprising the at least one oxygen sensor.

5. The catalyst assembly of claim 1, wherein the outlet portion and the cylindrical portion form a single piece.

6. The catalyst assembly of claim 1, wherein the outlet portion and the cylindrical portion comprise separate pieces.

7. The catalyst assembly of claim 6, wherein the outlet portion and the cylindrical portion are permanently coupled.

8. The catalyst assembly of claim 6, wherein the cylindrical portion has a diameter and the ratio of the diameter and the second diameter is approximately 19.7:1 to 34.5:1.

9. The catalyst assembly of 1, wherein the cylindrical portion comprises a second annular wall, and the at least one oxygen sensor connection is disposed along an upper half of the second annular wall.

10. The catalyst assembly of 1, comprising at least one additional non-oxygen sensor connection disposed on the cylindrical portion to enable the non-oxygen sensor coupled to the at least one non-oxygen sensor connection to be disposed perpendicular to the longitudinal axis of the cylindrical portion.

11. The catalyst assembly of claim 1, wherein the catalyst assembly comprises a three-way catalyst assembly.

12. A system, comprising:
a cylindrical portion configured to be coupled to a conically-shaped outlet portion of a three-way catalyst assembly along a fluid flow path exiting the conically-shaped outlet portion, wherein the cylindrical portion is configured to be coupled to a narrower end of the conically-shaped outlet portion; and
at least one oxygen sensor connection disposed on the cylindrical portion to enable an oxygen sensor coupled to the at least one oxygen sensor connection to be disposed perpendicular to a longitudinal axis of the cylindrical portion.

13. The system of claim 12, comprising the three-way catalyst.

14. The system of claim 13, wherein the three-way catalyst comprises an inlet portion and a central portion disposed between the inlet portion and the conically-shaped outlet portion, and wherein the central portion has a wider end of the conically-shaped outlet portion having a cross-sectional area, and the at least one oxygen sensor has a second diameter, and the ratio of the cross-sectional area to the second diameter is 16.4:1 m²/m to approximately 65.7:1 m²/m.

15. The system of 12, wherein the cylindrical portion comprises an annular wall, and the at least one oxygen sensor connection is disposed along an upper half of the annular wall.

16. The system of claim 15, wherein the cylindrical portion comprises at least one non-oxygen sensor connection disposed along the upper half of the annular wall.

17. The system of claim 16, wherein the cylindrical portion comprises two oxygen sensor connections and two non-oxygen sensor connections disposed along the upper half of the annular wall.

18. The system of claim 12, wherein the cylindrical portion has a diameter, and the ratio of the diameter to the second diameter is approximately 19.7:1 to 34.5:1.

19. A catalyst assembly configured to mount along an exhaust flow path of a reciprocating combustion engine, comprising:
a housing having an inlet portion, an outlet portion, a central portion disposed between the inlet portion and the outlet portion and configured to house one or more catalyst elements, and a flow path through the inlet portion, the central portion, and the outlet portion, wherein the outlet portion has a first end and a second end, the first end being coupled to the central portion, and the outlet portion comprises a conical wall having a first diameter that decreases from the first end to the second end;
a cylindrical portion coupled to and extending from the second end of the outlet; and
at least one oxygen sensor connection disposed on the cylindrical portion to enable an oxygen sensor coupled to the at least one oxygen sensor connection to be disposed perpendicular to a longitudinal axis of the cylindrical portion, wherein the central portion has a cross-sectional area adjacent the first end of the outlet portion, the at least one oxygen sensor has a second diameter, and the ratio of the cross sectional area to second diameter is 16.4:1 m²/m to approximately 65.7:1 m²/m.

20. The catalyst assembly of claim 19, wherein the catalyst assembly comprises a three-way catalyst.
